(19) United States
(12) Patent Application Publication
(10) Pub. No.: US 2022/0372799 A1
(43) Pub. Date: Nov. 24, 2022

(54) DEVICES, STRUCTURES, AND METHODS FOR CONTROLLING LATCHING OPERATIONS

(71) Applicant: Rivian IP Holdings, LLC, Plymouth, MI (US)

(72) Inventors: David Boyer, Irvine, CA (US); Marcus Merideth, Westland, MI (US)

(21) Appl. No.: 17/325,408

(22) Filed: May 20, 2021

(51) Int. Cl. E05B 81/20; E05B 81/06; E05B 81/42; E05B 81/66; E05B 85/04; E05B 83/24

(52) U.S. Cl. CPC E05B 81/21; E05B 81/06; E05B 81/42; E05B 81/66; E05B 85/04; E05B 83/243

(57) ABSTRACT

Various disclosed embodiments include illustrative devices, systems, and methods. In an illustrative embodiment, a device includes a latch motor configured to generate a power value, a position sensor configured to generate a striker pin position signal, a processor configured to communicate with the latch motor and the position sensor, and a memory configured to store computer-executable instructions. The computer-executable instructions are configured to cause the processor to determine the striker pin position in response to the generated striker pin position signal, detect an obstruction in response to the striker pin position and the power value, and perform an anti-pinch function in response to the detected obstruction.

### INTRODUCTION

The present disclosure relates to automatic closing devices. The statements in this section merely provide background information related to the present disclosure and may not constitute prior art.

Pinch hazards exist with powered closure systems. Resistive pinch strips or force sensors are used by some powered closure systems to detect obstructions. Not all applications are able to use resistive pinch strips due to structural design or force sensors due to cost or applicability.

### BRIEF SUMMARY

Various disclosed embodiments include illustrative devices, systems, structures, and methods.

In an illustrative embodiment, a device includes a latch motor configured to generate a power value, a position sensor configured to generate a striker pin position signal, a processor configured to communicate with the latch motor and the position sensor, and a memory configured to store computer-executable instructions. The computer-executable instructions are configured to cause the processor to determine the striker pin position in response to the generated striker pin position signal, detect an obstruction in response to the striker pin position and the power value, and perform an anti-pinch function in response to the detected obstruction.

In another illustrative embodiment, a structure includes a compartment and a latch device. The compartment includes a storage area, a panel hingedly attachable to the storage area, and a striker pin attachable to the panel. The latch device is configured to receive the striker pin. The latch device includes a latch motor configured to generate a power value, a position sensor configured to generate a striker pin position signal, a processor configured to communicate with the latch motor and the position sensor, and a memory configured to store computer-executable instructions. The computer-executable instructions are configured to cause the processor to determine the striker pin position in response to the generated striker pin position signal, detect an obstruction in response to the striker pin position and the power value, and perform an anti-pinch function in response to the detected obstruction.

In another illustrative embodiment, a method includes determining position of a striker pin, receiving a power value from a latch motor, detecting an obstruction in response to the position of the striker pin and the power value, and performing an anti-pinch function in response to the detected obstruction.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is an illustration in partial schematic form of an illustrative structure in an anti-pinch configuration.

FIG. 2 is a block diagram of illustrative components used in anti-pinch operations within a structure.

FIG. 3 is a perspective view of a storage compartment of a structure.

FIG. 4 is a perspective view of a latch.

FIG. 5 is a partial cutaway view of the latch of FIG. 4.

FIG. 6 is a current limit graph used for the anti-pinch operations by the components of FIG. 2.

FIG. 7 is a flow diagram of an illustrative method for anti-pinch operations.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative devices, structures, and methods. As will be explained below, such embodiments can provide anti-pinch closing operations.

For example, various devices described herein may or may not include processors, computer processing units (CPU), microcontrollers, logic devices, programmable systems on chip, field programmable arrays units, memory chips, among other components described or contemplated herein.

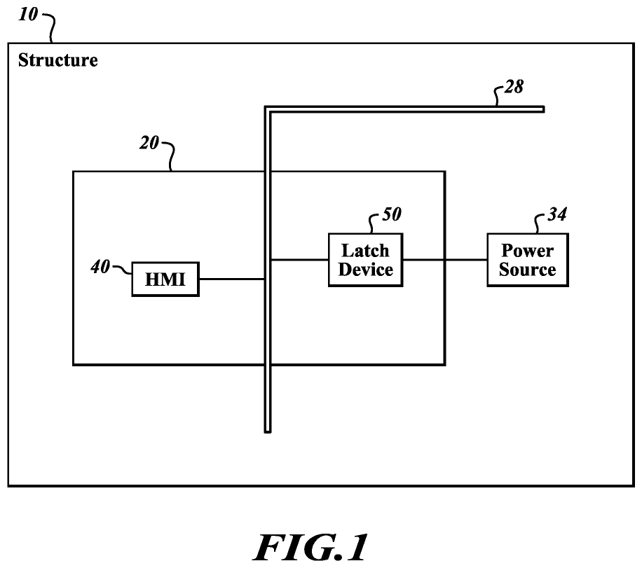

Referring to FIG. 1, in various embodiments an illustrative structure 10 may be configured in an anti-pinch configuration. In various embodiments the illustrative structure 10 includes a power source 34 and a system 20 for detecting obstructions during a closing operation of a hood, cover, door, or the like. It will be appreciated that the structure 10 may be any structure whatsoever that has a storage compartment. In various embodiments the structure 10 may be a stationary structure, such as a building or the like, or a moveable structure, such as a vehicle like a motor vehicle, a trailer, a marine vessel, a train, an aircraft, or the like. In various embodiments the structure 10 may include a human-machine interface (HMI) 40 and a latch device 50, both of which will be described in more detail below.

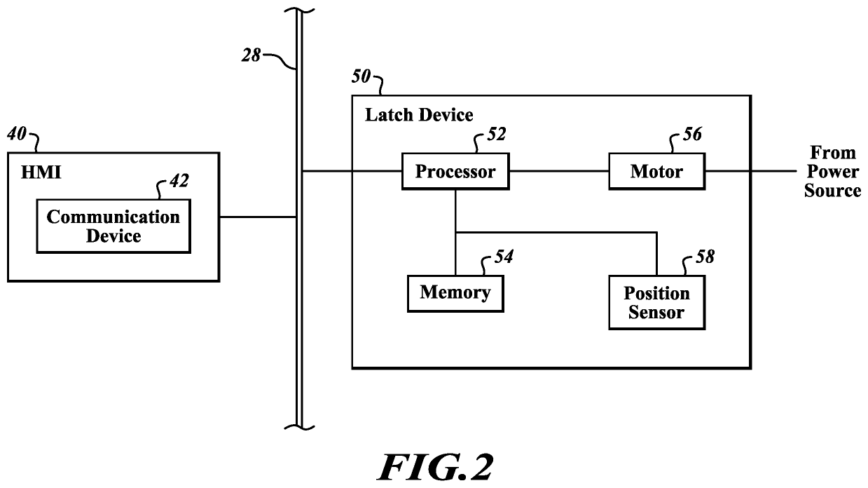

Referring additionally to FIG. 2, various illustrative components may be used in anti-pinch operations within the structure 10. In various embodiments the HMI 40 and the latch device 50 may communicate with each other and with numerous other vehicle components via a network such as a peer-to-peer network bus 28, such as a controller area network (CAN) bus. Other peer-to-peer network buses, such as a local area network (LAN), a wide area network (WAN), or a value-added network (VAN), may also be used for enabling communication between the components connected to the peer-to-peer network.

In various embodiments, the HMI 40 may include a communication device 42, mechanical buttons or switches, or selectable graphical user interface (GUI) features presented on a vehicle display device(s) or via an application program executable by a person electronic device. The communication device 42 is configured to receive an initiate a closing operation signal from an operator using an actuator, such as a trunk, hood, or frunk activation button disposed on a key fob, on a GUI, a button disposed within the structure 10 proximate to the trunk/storage compartment, or any suitable signal from any suitable signal source.

In various embodiments and given by way of example only and not of limitation, the communication device 42 may include a receiver, such as without limitation, a radio frequency receiver, an infrared receiver or the like. The communication device 42 may use encryption techniques to communicate with a key fob or the like. The encryption techniques may include using a rolling or hopping code technique or the like.

In various embodiments the latch device 50 may include a latch motor 56, a position sensor 58, a processor 52 configured to communicate with the latch motor 56 and the position sensor 58, and a memory 54 configured to store computer-executable instructions. The latch 50 device is described in more detail below.

In various embodiments the latch motor 56 is configured to send a power value to the processor 52. The power value may be amount of watts or current the latch motor 56 is current drawing. It will be appreciated that the latch motor 56 may be any type of electrical motor whatsoever as desired. Electrical motors are well known and further description of their construction and operation is not necessary for a person of skill in the art to understand disclosed subject matter.

In various embodiments the position sensor 58 is configured to generate a striker pin position signal. The processor 52 is configured to communicate with the position sensor 58 to receive the striker pin position signal. Illustrative details regarding the position sensor 58 and generation of the striker pin position signal will be discussed below.

In various embodiments the computer-executable instructions are configured to cause the processor 52 to determine the striker position in response to the generated striker position signal, detect an obstruction in response to the striker pin position and the power value, and perform an anti-pinch function in response to the detected obstruction.

In various embodiments, the computer-executable instructions are configured to cause the processor 52 to perform the anti-pinch function by instructing the latch motor 56 to apply an opening force to the striker pin 64.

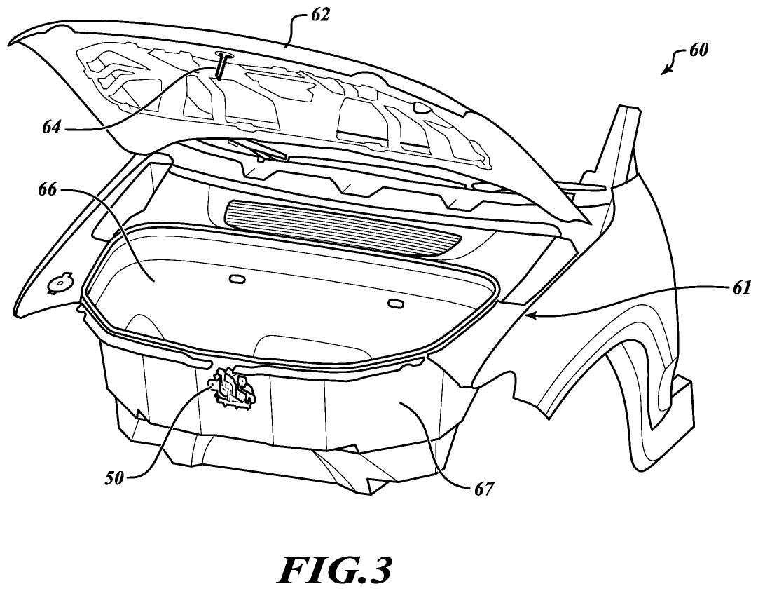

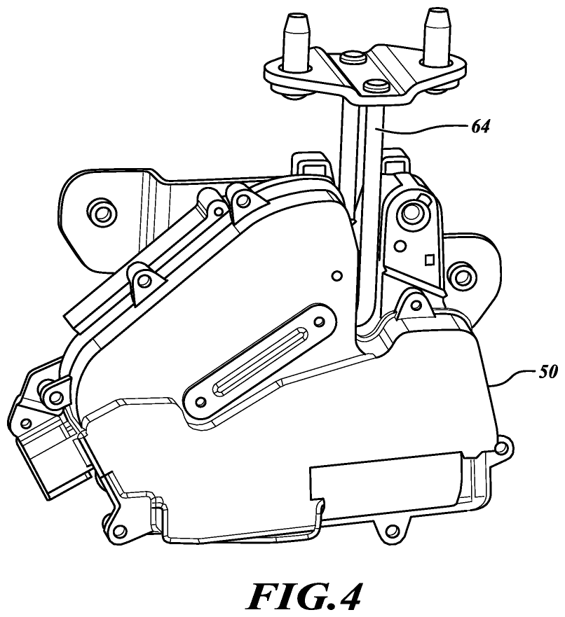

Referring additionally to FIG. 3, in various embodiments an illustrative structure 60 includes a storage compartment 61. The storage compartment 61 includes a storage area 66 having a panel 62 hingedly attachable to a base section 67. The latch device 50 is disposed at a side of the base section 67. A striker pin 64 is disposed on a side of the panel 62, such that the striker pin 64 is receivable by the latch device 50 (FIG. 4) when the panel 62 is closing over the storage area 66.

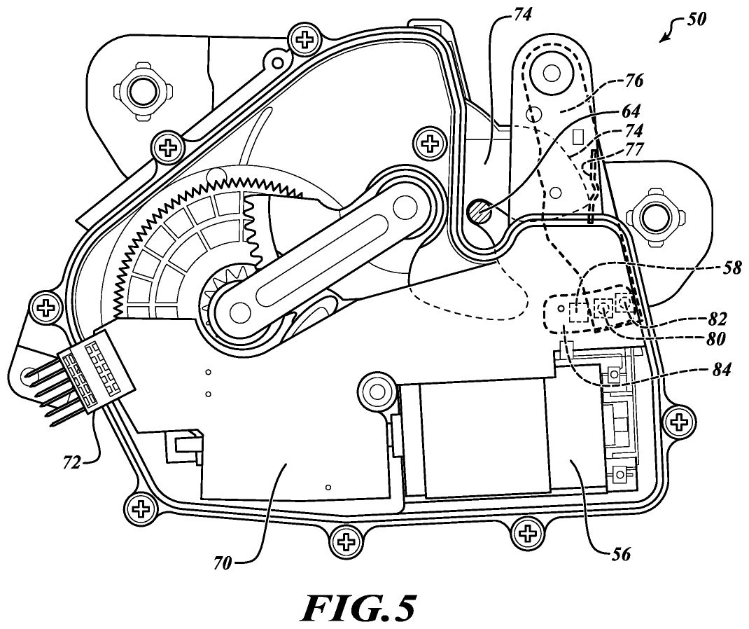

Referring additionally to FIGS. 4 and 5, in various embodiments the latch device 50 may include various components in addition to the latch motor 56, the position sensor 58, the processor 52, and the memory 54. For example, in various embodiments the latch device may include a latch 74, a cam 76, and the position sensor 58. The latch 74 is configured to move initially due to the striker pin 64 making contact with the latch 74. Later, the latch 74 is rotatably driven by the latch motor 56. The cam 76 is configured to rotate about a pivot point in response to the latch 76 making contact with a cam profile 77 of the cam 76. The position sensor 58 is configured to generate a cam position signal.

In various embodiments, the latch device 50 includes magnets 80 and 82 disposed on a free end of the cam 76. The position sensor 58 is disposed on a mounting plate 84 that is attached adjacent to the free end of the cam 76. As discussed below, the position sensor 58 is configured to generate a signal that represents a position of the magnets 80 and 82. The computer-executable instructions are further configured to cause the processor 52 to detect the position of the striker pin 64 in response to the signal of the position of the magnets 80 and 82.

In various embodiments, detection of the obstruction may further include identifying a first power threshold value in response to the position of the striker pin 64 being within a first range of positions and detecting the obstruction in response to the power value being greater than the first power threshold value.

In various embodiments, detection of the obstruction may further include identifying a second power threshold value in response to the position of the striker pin 64 being within a second range of positions and detecting the obstruction in response to the power value being greater than the second power threshold value.

In various embodiments, the position sensor 58 is configured to generate a signal that represents a position of the magnets 80 and 82. In various embodiments the position sensor 58 may be any device that can sense a change in magnetic field, such as without limitation a Hall effect sensor or the like. Given by way of example only and not of limitation, the position sensor 58 may include a Hall effect sensor, a semiconducting magnetoresistor, a ferromagnetic magnetoresistor, a fluxgate sensor, a superconducting quantum interference device (SQUID), a resonant sensor, an induction magnetometer, a linear variable differential transformer, an inductosyn, a synchro and a resolver, an Eddy current sensor, a variable reluctance sensor, a magnetic encoder, a permanent magnet linear contactless displacement sensor, a magnetoresistive position sensor, a reed contact, Wiegand wires, a magnetic force and torque sensors, a magnetic flowmeter, and a current sensor.

In various embodiments and given by way of example only and not of limitation, the power source 34 may include a device configured to generate electrical power for use by components of the structure 10. The power source 34 may be a grid power source, a generator, a battery, or comparable power creating devices. The battery may suitably include high energy rechargeable batteries that store electrical charge and discharge electrical current upon request. The battery may be structured in any desirable form, such as, without limitation, cylindrical, pouch, prismatic, massless, or other comparable forms. Generally, the battery includes Li-ion batteries, such as without limitation Nickel Cobalt Aluminum batteries, Lithium Manganese Cobalt batteries, or Lithium Manganese Oxide batteries. However, other materials may be used for providing comparable recharging, energy density, and energy discharge capabilities.

In various embodiments, the latch device 50 includes a printed circuit board 70 configured to receive and electrically connect the processor 52, the memory 54, the motor 56, and the position sensor 58. The latch device 50 includes a signal and power plug 72 disposed at an edge of the printed circuit board 70 for providing communication signals with the HMI 40 and power from the power source 34.

It will be appreciated that the functions described herein for the latch device 50 may be distributed between other data processing components of the structure 10, or to other devices that are in communication with components of the structure 10.

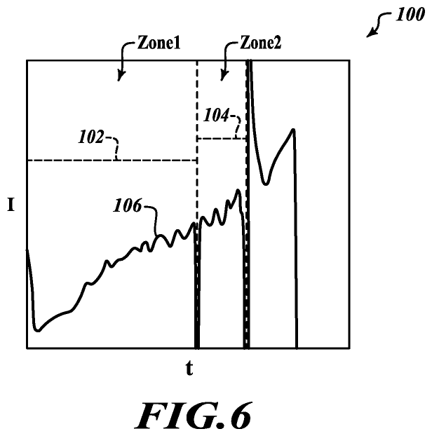

Referring additionally to FIG. 6, in various embodiments an illustrative current limit graph 100 identifies multiple current threshold zones used by the latch device 50 for determining whether an obstruction exists in anti-pinch operations. A first zone (zone 1) identifies a first current threshold value 102 for a first period of time and a second zone (zone 2) identifies a second current threshold value 104 for a second period of time. The start of time for zone 1 may begin when the processor 52 determines that the striker pin 64 is at a predefined start position in response to a signal from the position sensor 58. The latch motor 56 may start operating upon the determination that the striker pin 64 is at the predefined start position. As the latch motor 56 is operating, the latch motor 56 is drawing current from the power source 34. Line 106 represents an illustrative current value for the latch motor 56. The latch motor 56 sends the amount of drawn current to the processor 52 for comparison to the first current threshold value 102 or the second current threshold value 104 identified in the graph 100 depending upon the amount of time that has elapsed since the determination of the predefined start position. If the panel 62 is not being obstructed, the latch motor 56 draws a current value below the respective current threshold values 102 or 104. If, however, the panel 62 is being obstructed, the latch motor 56 may draw a current value greater than the respective current threshold values 102 or 104. In the situation where the latch motor 56 is drawing a current value greater than the respective current threshold values 102 or 104, the processor 52 determines that an obstruction is present and initiates an anti-pinch function. More than one threshold zone may be due to the latch motor 56 requiring more current to rotate the latch 74 as the striker pin 64 is further received within the latch device 50. After zone 2, no threshold value is applied to the current value drawn by the latch motor 56 due to an improbability of an obstruction being pinched by the panel 62 in the edge of the storage area 66. It will be appreciated by those of ordinary skill in the art that more than two zones (two threshold values) may be used depending upon analysis of current used by the latch motor 56 during the latching process. It will be appreciated by those of ordinary skill in the art that the current threshold value need not be zonal but could be calculated dynamically using historical data.

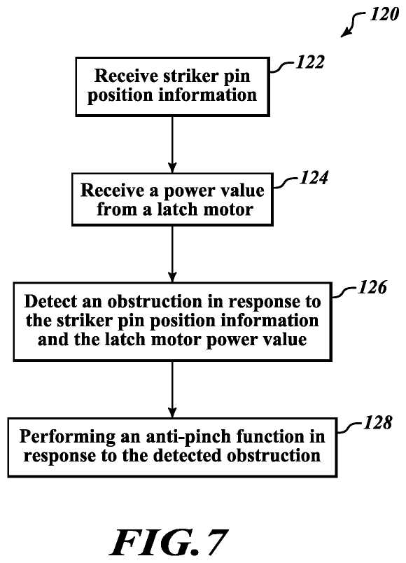

Referring additionally to FIG. 7, in various embodiments an illustrative process 120 is provided for anti-pinch operations. At a block 122, position of a striker pin is determined. At a block 124, a power value is received from a latch motor. At a block 126, an obstruction is detected in response to the position of the striker pin and the power value. At a block 128, an anti-pinch function is performed in response to the detected obstruction.

In some embodiments, detecting the obstruction may include identifying a power threshold value in response to the position of the striker pin and detecting the obstruction in response to the power value being greater than the power threshold value.

In some embodiments, performing the anti-pinch function may include instructing the latch motor to apply an opening force to the striker pin.

In some embodiments, determining the position of the striker pin may include determining a position of a latch cam configured to rotate about a pivot point in response to location of the striker pin.

In some embodiments, determining the position of the latch cam may include sensing position of a magnet attachable to the latch cam and determining the position of the striker pin further includes determining the position of the striker pin in response to the sensed position of the magnet.

In some embodiments, detecting the obstruction may further include identifying a first power threshold value in response to the position of the striker pin being within a first range of positions and detecting the obstruction in response to the power value being greater than the first power threshold value.

In some embodiments, detecting the obstruction may further include identifying a second power threshold value in response to the position of the striker pin being within a second range of positions and detecting the obstruction in response to the power value being greater than the second power threshold value.

Those skilled in the art will recognize that at least a portion of the ECU 30, the HMI 40, processors, controllers, components, devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and application programs, one or more interactive devices (e.g., a touch pad, a touch screen, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term controller, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of controller (e.g., at a first time), as a second type of controller (e.g., at a second time, which may in some instances coincide with, overlap, or follow a first time), and/or as a third type of controller (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first controller that has a first purpose, then a second controller that has a second purpose and then, a third controller that has a third purpose, and so on. The transition of a reconfigurable and/or controllable component may occur in as little as a few nanoseconds, or may occur over a period of minutes, hours, or days.

In some such examples, at the time the controller is configured to carry out the second purpose, the controller may no longer be capable of carrying out that first purpose until it is reconfigured. A controller may switch between configurations as different components/modules in as little as a few nanoseconds. A controller may reconfigure on-the-fly, e.g., the reconfiguration of a controller from a first controller into a second controller may occur just as the second controller is needed. A controller may reconfigure in stages, e.g., portions of a first controller that are no longer needed may reconfigure into the second controller even before the first controller has finished its operation. Such reconfigurations may occur automatically, or may occur through prompting by an external source, whether that source is another component, an instruction, a signal, a condition, an external stimulus, or similar.

For example, a central processing unit or the like of a controller may, at various times, operate as a component/module for displaying graphics on a screen, a component/module for writing data to a storage medium, a component/module for receiving user input, and a component/module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components/modules, the example includes the possibility that the same hardware may implement more than one of the recited components/modules, either contemporaneously or at discrete times or timings. The implementation of multiple components/modules, whether using more components/modules, fewer components/modules, or the same number of components/modules as the number of components/modules, is merely an implementation choice and does not generally affect the operation of the components/modules themselves. Accordingly, it should be understood that any recitation of multiple discrete components/modules in this disclosure includes implementations of those components/modules as any number of underlying components/modules, including, but not limited to, a single component/module that reconfigures itself over time to carry out the functions of multiple components/modules, and/or multiple components/modules that similarly reconfigure, and/or special purpose reconfigurable components/modules.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A device comprising:
a latch motor configured to generate a power value;
a position sensor configured to generate a striker pin position signal;
a processor configured to communicate with the latch motor and the sensor; and
a memory configured to store computer-executable instructions configured to cause the processor to:
determine a striker pin position responsive to the generated striker pin position signal;
detect an obstruction responsive to the striker pin position and the power value; and
perform an anti-pinch function responsive to the detected obstruction.

2. The device of claim 1, wherein detecting includes:
identifying a power threshold value responsive to the striker pin position; and
detecting the obstruction responsive to the power value being greater than the power threshold value.

3. The device of claim 1, wherein performing the anti-pinch function includes instructing the latch motor to apply an opening force to the striker pin.

4. The device of claim 1, further comprising:
a latch configured to be rotatably driven by the latch motor;
a cam configured to rotate about a pivot point responsive to a location of the striker pin received by the latch; and
a cam position sensor configured to generate a cam position signal.

5. The device of claim 4, further comprising a magnet; and
wherein the position sensor includes a magnet position sensor configured to generate a signal indicative of a position of the magnet relative to the magnet position sensor, the instructions being further configured to cause the processor to detect position of the striker pin responsive to the signal indicative of the position the magnet.

6. The device of claim 1, wherein detecting the obstruction further includes:
identifying a first power threshold value responsive to the position of the striker pin being within a first range of positions; and
detecting the obstruction responsive to the power value being greater than the first power threshold value.

7. The device of claim 1, wherein detecting the obstruction further includes:
identifying a second power threshold value responsive to the position of the striker pin being within a second range of positions; and
detecting the obstruction responsive to the power value being greater than the second power threshold value.

8. A structure comprising:
a compartment;
a panel hingedly attachable to a storage area; and
a striker pin attachable to the panel; and
a latch device configured to receive the striker pin, the latch device including:
a latch motor configured to generate a power value;
a position sensor configured to generate a striker pin position signal;
a processor configured to communicate with the latch motor and the sensor; and
a memory configured to store computer-executable instructions configured to cause the processor to:
determine the striker position responsive to the generated striker position signal;
detect an obstruction responsive to the striker pin position and the power value; and
perform an anti-pinch function responsive to the detected obstruction.

9. The structure of claim 8, wherein performing the anti-pinch function includes instructing the latch motor to apply an opening force to the striker pin.

10. The structure of claim 8, wherein the device further includes:
a latch configured to be rotatably driven by the latch motor;
a cam configured to rotate about a pivot point responsive to a location of the striker pin received by the latch; and
a cam position sensor configured to generate a cam position signal.

11. The structure of claim 10, wherein:
the device further includes a magnet; and
the position sensor includes a magnet position sensor configured to generate a signal of indicative a position of the magnet relative to the magnet position sensor, the instructions being further configured to cause the processor to detect position of the striker pin responsive to the signal indicative of the position the magnet.

12. The structure of claim 8, wherein detecting the obstruction further includes:
identifying a first power threshold value responsive to the position of the striker pin being within a first range of positions; and
detecting the obstruction responsive to the power value being greater than the first power threshold value.

13. The structure of claim 12, wherein detecting the obstruction further includes:
identifying a second power threshold value responsive to the position of the striker pin being within a second range of positions; and
detecting the obstruction responsive to the power value being greater than the second power threshold value.

14. A method comprising:
determining position of a striker pin;
receiving a power value from a latch motor;
detecting an obstruction responsive to the position of the striker pin and the power value; and
performing an anti-pinch function responsive to the detected obstruction.

15. The method of claim 14, wherein detecting includes:
identifying a power threshold value responsive to the position of the striker pin; and
detecting the obstruction responsive to the power value being greater than the power threshold value.

16. The method of claim 14, wherein performing the anti-pinch function includes instructing the latch motor to apply an opening force to the striker pin.

17. The method of claim 14, wherein determining the position of the striker pin includes determining a position of a latch cam configured to rotate about a pivot point responsive to location of the striker pin.

18. The method of claim 17, wherein:
determining the position of the latch cam includes sensing position of a magnet relative to a magnet position sensor; and
determining the position of the striker pin further includes determining the position of the striker pin responsive to the sensed position of the magnet.

19. The method of claim 14, wherein detecting the obstruction further includes:
identifying a first power threshold value responsive to the position of the striker pin being within a first range of positions; and
detecting the obstruction responsive to the power value being greater than the first power threshold value.

20. The method of claim 19, wherein detecting the obstruction further includes:
identifying a second power threshold value responsive to the position of the striker pin being within a second range of positions; and
detecting the obstruction responsive to the power value being greater than the second power threshold value.
